(19) United States
(12) Patent Application Publication
(10) Pub. No.: US 2016/0091133 A1
(43) Pub. Date: Mar. 31, 2016

(54) TRIPOD HEAD

(71) Applicant: Zhihua Li, Zhongshan City (CN)

(72) Inventor: Zhihua Li, Zhongshan City (CN)

(21) Appl. No.: 14/499,054

(22) Filed: Sep. 26, 2014

(51) Int. Cl. F16M 11/14

(52) U.S. Cl. CPC F16M 11/14

(57) ABSTRACT

A tripod head is designed for solving the problem that in the prior art, a tripod head cannot take the undamped motion only in the horizontal unidirection. The tripod head comprises a ball sleeve. The upper part of the ball sleeve is provided with an opening. A spherical joint for being connected with a quick release plate connector is arranged in the opening. A rotatable chassis is arranged under the lower part of the ball sleeve. The middle part of the chassis is provided with a mounting hole for being connected with a tripod, wherein a unidirectional positioning regulating knob is arranged on the outer surface of the ball sleeve and the axis of the unidirectional positioning regulating knob is positioned on the same horizontal plane as the center of the spherical joint.

### BACKGROUND

1. Field

The present disclosure relates to photographic auxiliary equipment, in particular to a tripod heads.

2. Description of Related Art

A tripod head matches with a tripod and is used for regulating a shooting angle of a camera. When the tripod head is in use, it is mounted on a tripod. Then a quick release plate matched with the head is screwed on the camera and the camera is mounted on the tripod. The tripod can allow horizontal rotation in the range of 360 degrees and pitching up or down to one or more certain camera angles.

Currently systems have a spherical head that adapts to a spherical joint. In such cases, the tripod head cannot take undamped motion in the horizontal direction such that birds and moving objects cannot be rapidly shot and sports photography cannot be carried out.

### SUMMARY

This disclosure provides a tripod head which can take undamped motion in a horizontal direction. The tripod head comprises a ball sleeve, wherein the upper part of the ball sleeve is provided with an opening. A spherical joint for being connected with a quick release plate connector is arranged in the opening, a rotatable chassis is arranged under the lower part of the ball sleeve, and the middle part of the chassis is provided with a mounting screw hole for being connected with a tripod.

Two positioning holes are arranged in the center horizontal plane of the spherical joint with a circular arc of about 90 degrees therebetween. The positioning holes are used for regulating the direction of the quick release plate connector. A positioning regulating knob which corresponds to the position of one positioning hole is arranged on the outer surface of the ball sleeve. The axis of the positioning regulating knob and the center of the spherical joint are positioned on the same horizontal plane.

The positioning regulating knob comprises an internal connection barrel, a screw shaft and a positioning pin. The internal connection barrel is connected with the internal screw thread of the ball sleeve and the other end of the internal connection barrel is connected with the positioning regulating knob. The screw shaft is connected with internal screw thread of the positioning regulating knob, and the positioning regulating knob may be rotated to drive the other end of the screw shaft to be in contact with the corresponding positioning hole.

When the tripod head is in use, the quick release plate connector rotates to a concave part of the opening of the ball sleeve to be positioned and the positioning regulating knob is rotated to take the undamped motion in the horizontal direction.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a structural diagram of an embodiment of a tripod head according to this disclosure; and

FIG. 2 is a sectional view of the center horizontal plane of a spherical joint of the tripod head of FIG. 1.

### DETAILED DESCRIPTION

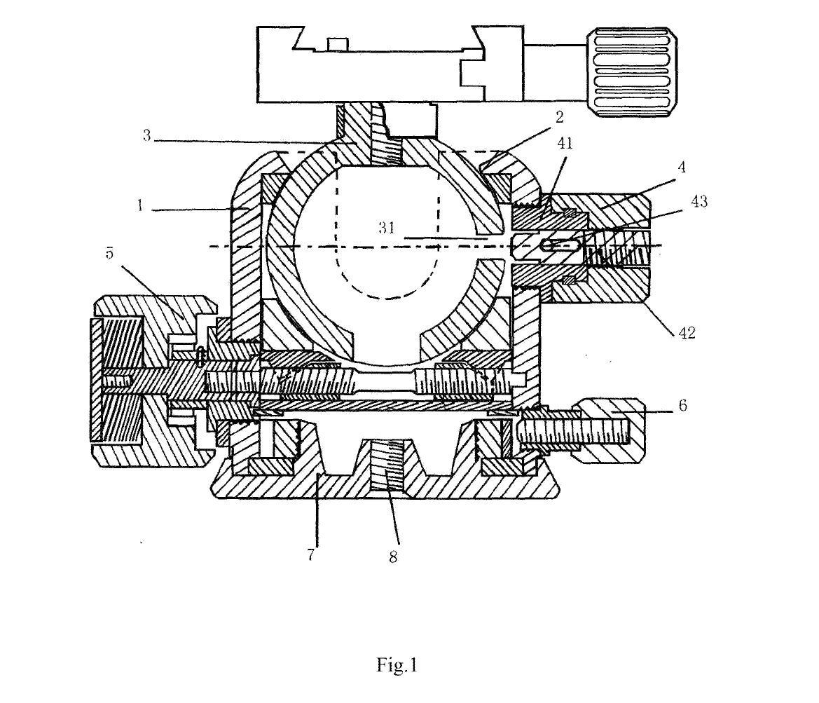

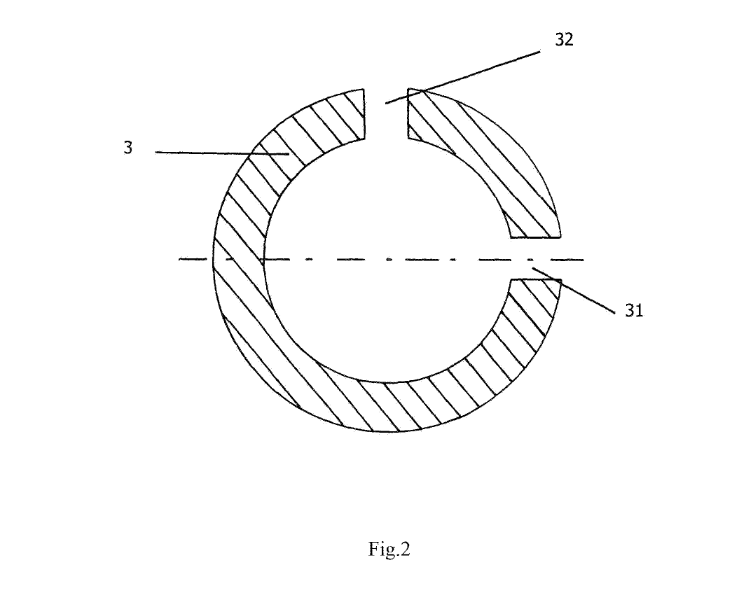

Reference will now be made to the drawings wherein like reference numerals identify similar structural features or aspects of the subject disclosure. For purposes of explanation and illustration, and not limitation, an illustrative view of an embodiment of a tripod head in accordance with the disclosure is shown in FIGS. 1 and 2.

In at least one aspect of this disclosure, referring to FIG. 1, a tripod head includes a ball sleeve 1 and an opening 2. A spherical joint 3 for being connected with a quick release plate connector is arranged in the opening 2. A positioning regulating knob 4, a locking and/or damping knob 5 and a rotatable chassis positioning knob 6 are arranged on the outer surface of the ball sleeve 1. A rotatable chassis 7 is arranged under the lower part of the ball sleeve 1. The middle part of the chassis is provided with a mounting screw hole 8 for being connected with a tripod.

The spherical joint 3 is arranged in the opening 2 of the ball sleeve 1, two positioning holes 31 and 32 are arranged in the center horizontal plane of the spherical joint 3 with a circular arc of about 90 degrees therebetween, and the two positioning holes 31 and 32 are used for regulating the direction of the quick release plate connector;

The positioning regulating knob 4 is arranged on the outer surface of the ball sleeve 1. The axis of the positioning regulating knob 4 and the center of the spherical joint 3 can be positioned on the same horizontal plane. The positioning regulating knob 4 can include an internal connection barrel 41 and a screw shaft 42 and a positioning pin 43. The internal connection barrel 41 can be connected with the internal screw thread of the ball sleeve 1 and the other end of the internal connection barrel 41 can be connected with the positioning regulating knob 4.

The screw shaft 42 can be connected with the internal screw thread of the positioning regulating knob. The positioning pin 43 can be used to control rotation and travel positioning of the screw shaft 42.

The screw shaft 42 of the positioning regulating knob 4 corresponds to the positioning hole 31. The positioning regulating knob 4 may be rotated to drive the other end of the screw shaft 42 to be in contact with the positioning hole 31. As shown in FIG. 1, the locking knob 5, the rotatable chassis positioning knob 6, the rotatable chassis 7, and the mounting screw hole 8 connected with the tripod can respectively be any suitable embodiment thereof.

The tripod head has the characteristics that when the tripod head is in use, the quick release plate connector is regulated to a concave part of the opening 2 of the ball sleeve 1 to be positioned and the positioning regulating knob 4 is rotated to take the undamped motion only in the horizontal direction.

The methods and systems of the present disclosure, as described above and shown in the drawings, provide for a tripod with superior properties including taking undamped motion in a horizontal direction and/or only While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A tripod head, comprising:
a ball sleeve, wherein the upper part of the ball sleeve is provided with an opening;
a spherical joint for being connected with a quick release plate is arranged in the opening;
a rotatable chassis is arranged under the lower part of the ball sleeve;
the middle part of the chassis is provided with a mounting screw hole for being connected with a tripod;
a positioning regulating knob is arranged on the outer surface of the ball sleeve; and
the axis of the positioning regulating knob and the center of the spherical joint are positioned on the same horizontal plane.

2. The tripod head according to claim 1, wherein two positioning holes are arranged in the center horizontal plane of the spherical joint with a circular arc of about 90 degrees therebetween, wherein the positioning holes are used for regulating the direction of a quick release plate connector, and wherein one positioning hole is positioned at the inner side of the positioning regulating knob and corresponds to the positioning regulating knob.

3. The tripod head according to claim 2, wherein the positioning regulating knob is provided with an internal connection barrel and a screw shaft, wherein one end of the internal connection barrel is connected with the positioning regulating knob and the other end of the internal connection barrel is connected with the ball sleeve through the internal screw thread of the ball sleeve, and wherein one end of the screw shaft is connected with the positioning regulating knob through the internal screw thread of the positioning regulating knob and the other end of the screw shaft is in contact with an inner hole of the internal connection barrel.

4. The tripod head according to claim 3, wherein the screw shaft is provided with a rabbet and a positioning pin, wherein the positioning pin passes through the rabbet of the screw shaft to be connected with the inner wall of the internal connection barrel so as to control rotation and travel positioning of the screw shaft.
